(19) United States
(12) Patent Application Publication
(10) Pub. No.: US 2020/0255100 A1
(43) Pub. Date: Aug. 13, 2020

(54) LASHING BAR MADE OF A COMPOSITE MATERIAL AND METHOD OF MANUFACTURING SAME

(71) Applicant: OZ Industry Co., Ltd., Changwon-si (KR)

(72) Inventor: Young Hoan OH, Changwon-si (KR)

(73) Assignee: OZ Industry Co., Ltd., Changwon-si (KR)

(21) Appl. No.: 16/790,391

(22) Filed: Feb. 13, 2020

Related U.S. Application Data
(63) Continuation of application No. 15/549,557, filed on Aug. 8, 2017, now abandoned.

(30) Foreign Application Priority Data
Apr. 14, 2016 (KR) 10-2016-0045712

(51) Int. Cl. B63B 25/24; B63B 25/28; B60P 7/06; F16C 7/02; B29C 70/30

(52) U.S. Cl. CPC B63B 25/24; B63B 25/28; B63B 2025/285; F16C 7/026; B29C 70/30; B60P 7/06

(57) ABSTRACT

Disclosed is a lashing bar of a composite material formed through filament winding to provide light weight and capacity to withstand high tensile loads, and a method of manufacturing the same. The lashing bar includes continuous fibers with high tensile strength wound around the core in the center and the exteriors of thimbles with holes and encased by a composite material, and metal parts provided in certain areas where loads are concentrated.

### CROSS REFERENCE TO PRIOR APPLICATIONS

This application is a Continuation Application of U.S. patent application Ser. No. 15/549,557 (filed on Aug. 8, 2017), which is a National Stage patent application of PCT International Patent Application No. PCT/KR2017/002838 (filed on Mar. 16, 2017) under 35 U.S.C. § 371, which claims priority to Korean Patent Application No. 10-2016-0045712 (filed on Apr. 14, 2016), which are all hereby incorporated by reference in their entirety.

### BACKGROUND

The present invention relates to the equipment used for the lashing of containers. More specifically, the invention relates to a lashing bar made of a composite material formed through the filament winding process to provide light weight and capacity to withstand high tensile loads, and a method of manufacturing the same.

Generally, on-deck containers refer to the boxes used for the efficient and cost-saving storage and transport of cargo.

Recently, extra-large container ships were developed for the purpose of reducing the shipping costs of containers, and these ships will often carry some thousands of containers on deck stacked more than six tiers high.

FIG. 1 shows the conventional container lashing equipment that is commonly used now.

As illustrated in the figure, the conventional containers (10) are clamped together using Twistlocks (11), which fasten the upper and lower tiers of the containers (10), and then lashing bars (13) and turnbuckles (15) are secured on deck with a crisscross lashing arrangement to reinforce the strength to withstand inclined and horizontal loads.

Lashing bars are generally used on container ships to prevent containers from shifting and tilting during transportation at sea, and they connect the corner fittings and turnbuckles of containers.

As shown in FIGS. 2A and 2B, commonly used lashing bars are classified into eye type and knob type according their shapes.

The eye type lashing bar in FIG. 2A comprises a hook-shaped coupling member through which one end of the bar is secured to a container, and an oval coupling member on the other end.

The knob type lashing bar in FIG. 2B comprises a hook-shaped coupling member through which one end of the bar is secured to a container, and several stoppers on the other end to allow for length adjustments.

Meanwhile, a ship at sea moves in several degrees of motion, such as roll, pitch, and heave, and is affected by accelerations along the x, y, and z axes relative to different motions. Such acceleration causes a force on containers, which acts as a lashing force.

Lashing bars are therefore subject to strict control in accordance with marine safety control regulations so that containers are secured on deck with adequate strength higher than the design limit to withstand roll, pitch, and high winds while the ship moves at sea, and only those products whose performance has been tested by supervisory authorities are permitted to be used to meet the aforementioned standard.

To ensure adherence to these regulations, commonly used lashing bars are made of high tensile strength alloy steels including SCR4, SCM4, and SNCM8. However, products longer than 5 m weight from 20 to 25 kg each, and even products as long as 2.5 to 3 m weight 10 to 15 kg. These products cause fatigue in operators, as well as accidents during transportation, installation, and dismantling, resulting in such problems as reduced efficiency and avoidance of work.

### SUMMARY

It is therefore an object of the present invention to provide a lashing bar made of a composite material fabricated through filament winding and a method of manufacturing the same for the manufacture of lashing bars made of a composite material formed with continuous filament fibers that provides higher tensile strength at a lower specific gravity than any high-tensile steel.

In order to solve the aforementioned problem, the present invention provides a lashing bar made of a composite material comprising a bar-shaped central portion encased in a composite material through the winding of continuous fibers around the outer circumference of a metal cylindrical core which constitutes the core of the central portion; an oval coupling portion formed at one end of the aforementioned bar-shaped central portion and having wound continuous fibers attached to the holes of hook-type thimbles made from metal; and a hook-shaped coupling portion formed at the other end of the aforementioned bar-shaped central portion and having wound continuous fibers attached to the holes of two ring-type thimbles made from metal.

In order to solve the aforementioned problem, the invention also provides a method of manufacturing lashing bars of a composite material comprising (1) a step in which a forming mold for the aforementioned lashing bar is assembled and loaded onto a filament winding machine; (2) a step in which continuous fibers are wound around the outer circumference of the aforementioned loaded lashing bar forming mold through the filament winding technique; and (3) a step in which the filament wound composite product is cured to form a lashing bar.

An advantage of the present invention providing a lashing bar and a method of manufacturing the same is that it enables the manufacture of container lashing bars with light weight and capacity to withstand high tensile loads by forming a composite material through filament winding with continuous fibers including glass, carbon, and aramid fibers, which provide four to six times the tensile strength of high-tensile special steels at a specific gravity 25 to 35% lower than that of special steels, and by providing metal parts in certain areas where loads are concentrated.

Therefore, a lashing bar manufactured through the invention offers the advantages of maximizing efficiency during transportation and installation by radically lowering weight to 30 to 50% of the average weight of conventional metal lashing bars, thereby reducing accident rates and resolving the problem of work avoidance, and of allowing semi-permanent use by utilizing the corrosion resistance of the composite material, thereby solving the problem of limited service life for conventional metal products due to corrosion.

### BRIEF DESCRIPTION OF THE DRAWINGS

FIG. 1 shows conventional container lashing equipment.

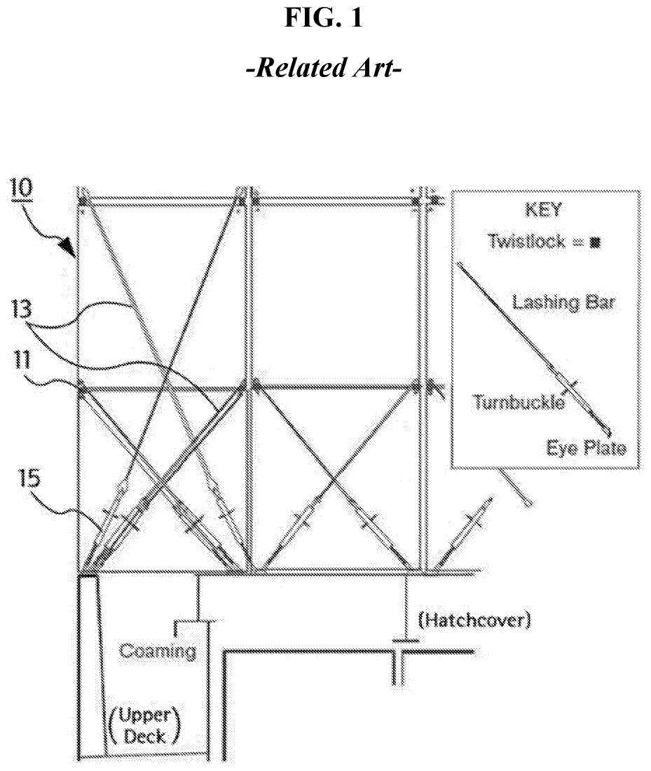

FIGS. 2A and 2B are illustrative views of the shapes of conventional lashing bars made from metal.

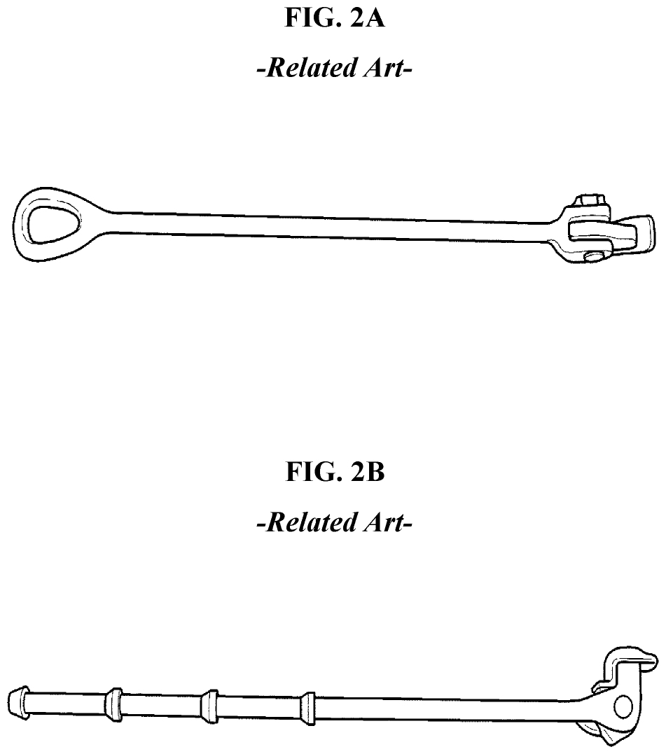

FIG. 3 is a process flow chart to describe a method of manufacturing a lashing bar of a composite material according to the present invention.

FIG. 4 is a part drawing used in the manufacturing method of FIG. 3.

FIG. 5A to 5C show the process of winding continuous fibers through the filament winding technique used in the manufacturing method of FIG. 3.

FIGS. 6 and 7 show the lashing bar made of a composite material according to the invention.

FIG. 8 illustrates a table which shows tensile strengths of glass, carbon, aramid, and polyethylene fibers.

### DETAILED DESCRIPTION

The following is a detailed description of a preferred embodiment of the present invention with reference to the accompanying drawings.

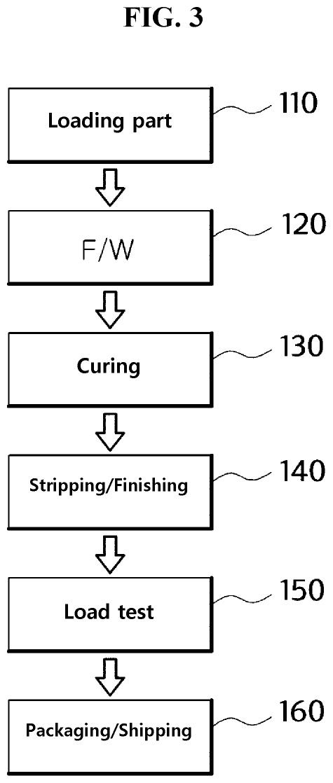

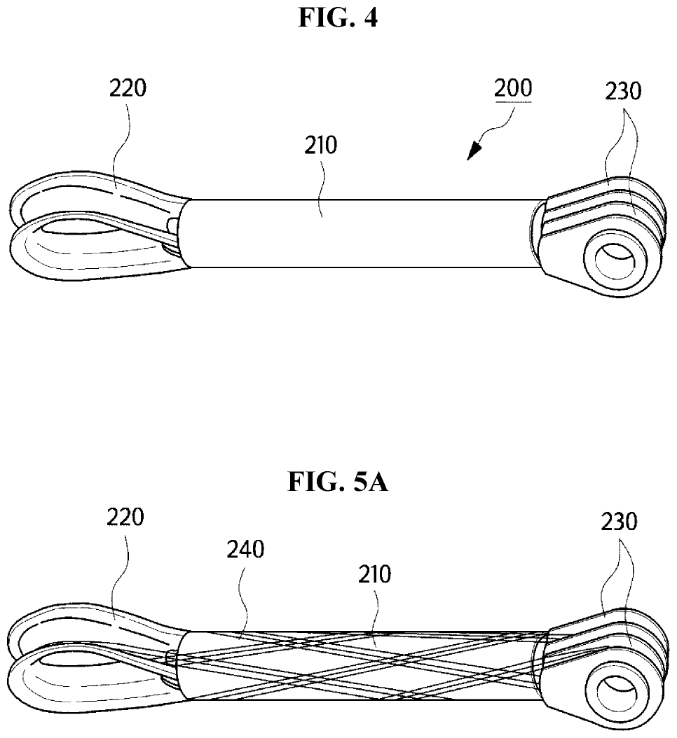

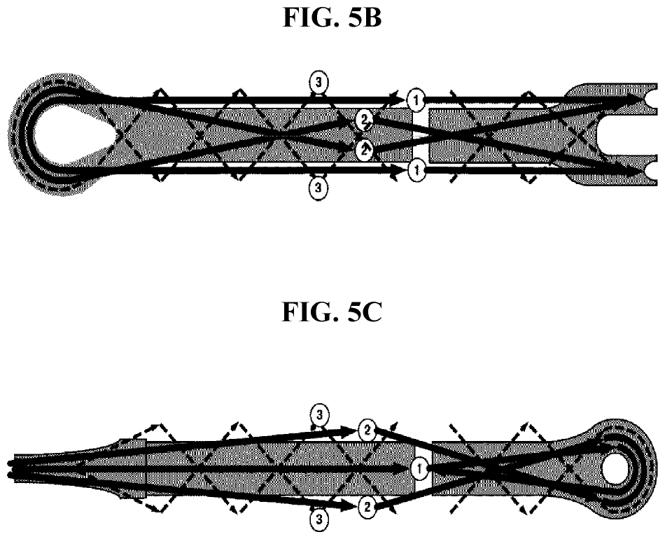

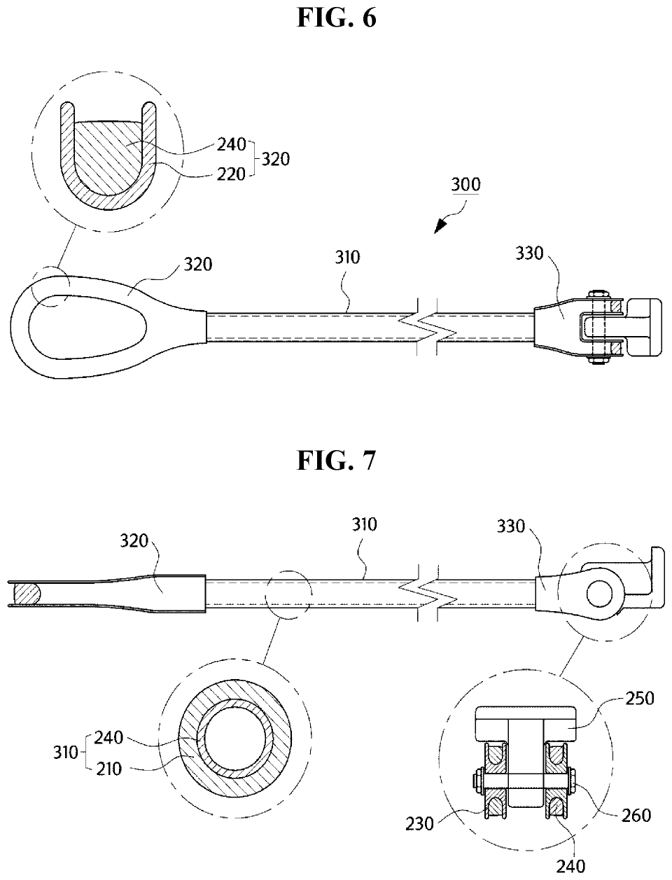

FIG. 3 is a process flow chart to describe a method of manufacturing a lashing bar of a composite material according to the present invention, FIG. 4 is a part drawing used in the manufacturing method of FIG. 3, FIG. 5A to 5C show the process of winding continuous fibers through the filament winding technique used in the manufacturing method of FIG. 3, and FIGS. 6 and 7 show the lashing bar made of a composite material according to the invention.

To begin with, a method of manufacturing a lashing bar made of a composite material according to the present invention with reference to FIG. 3 is described as the step in which the prepared parts are assembled as shown in FIG. 4 and then loaded onto the filament winding machine (step 110).

According to this embodiment, the prepared parts consist of a cylindrical core (210), hook-type thimbles (220), and two ring-type thimbles (230).

The said cylindrical core (210) constitutes the core of the center portion and a metal pipe thick enough to resist bending when tension is applied during the winding of continuous fibers.

On one end of the cylindrical core (210) are assembled the hook-type thimbles (220) and on the other end are assembled one or two ring-type thimbles (230) facing each other.

In this embodiment, the aforementioned thimbles (220, 230) are made from metal and serve as a framework for the winding of continuous fibers during the lashing bar manufacturing process and later constitute the coupling portion of a lashing bar that can be coupled to the hooks of a container and put on other rings.

The parts thus assembled are loaded onto the filament winding machine as the lashing bar forming mold (200) and then help wind the continuous fibers (240) according to the filament winding program (step 120).

Generally, the filament winding process is a fabrication technique by which the continuous filaments of fiber-reinforced plastic (FRP) are wound around and attached onto the surface of a mandrel through the application of tension, heated and cured, and then removed from the mandrel. The technique is used in the manufacture of rotationally symmetrical structures such as cylindrical or spherical pressure vessels, tanks, and pipes.

In the present invention, as shown in FIG. 5A or 5C, the aforementioned filament winding technique is applied to the alignment of the continuous fibers forming a composite material in the lashing bar forming mold (200) assembled with the central portion core (210) and the thimbles on both ends (220, 230).

In aligning continuous fibers, as shown in the plan view of FIG. 5B, the most effective method of transmitting lengthwise tensile strength is the sub-step of \textcircled{1} by which to align the continuous fibers (240) passed through the holes of the hook-type thimbles (220) lengthwise (0 degrees).

Then, in the second alignment sub-step (\textcircled{2}), the continuous fibers (240) are aligned at degrees not exceeding ±15 to minimize the loss of tensile strength while the fibers are evenly distributed lengthwise along the cylindrical core (210).

Then, in the third alignment sub-step (\textcircled{3}), the continuous fibers (240) are aligned at ±40 to ±50 degrees to efficiently and adequately resist torsion loads that arise during installation.

In alignment order of \textcircled{1}→\textcircled{2}→\textcircled{3}, the winding of the continuous fibers (240) is to be repeated a certain number of times until the fibers are attached through the application of tension to the surface of the lashing bar forming mold (20).

FIG. 5c shows a front view of the alignment of the continuous fibers.

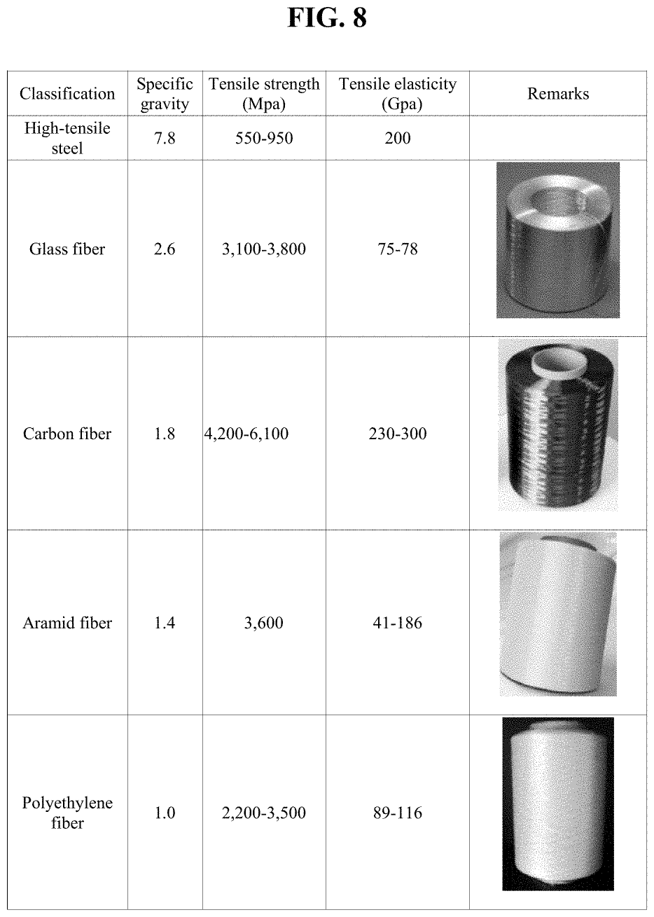

The types of the continuous fibers (240) to be applied in the present invention are glass, carbon, aramid, and polyethylene fibers. The tensile strengths of these fibers are generally higher than the tensile strength of high-tensile steels as shown in Table in FIG. 8.

While the continuous fibers (240) forming the aforementioned composite material are wound and attached by tension to the surface of the lashing bar forming mold (200), the product is mounted in a rotating curing oven and then cured (step 130). Then, the product is transferred to the stripping/finishing process by which sharp edges on the surface are removed in a finishing workshop equipped with a dust collector (step 140).

Next, the stripped/finished product is tested for its capacity to withstand tensile and torsion loads (step 150) and, when the product meets its requirements, it is packaged and shipped (step 160).

A lashing bar made of a composite material manufactured and finished through the aforementioned processes according to the present invention will have the shape shown in FIGS. 6 and 7.

As shown in FIGS. 6 and 7, the lashing bar made of a composite material provided in the present invention (300) is an eye type comprising a bar-shaped central portion (310), an oval coupling portion on one end (320) and a hook coupling portion on the opposite end (330).

As shown in an enlarged view, the oval coupling portion (320) comprises a hook-type metal thimble (220) featuring a hole into which the continuous fiber composite material (240) is integrated.

In the middle of the bar-shaped central portion (310) is located the metal cylindrical core (210) and on its outer circumference, the continuous fiber composite material (240) is integrated.

While its two metal ring-type thimbles (230) face each other, the hook coupling portion (330) is coupled to the container hook (250) in between the thimbles, and the bolts (260) pass the holes on the thimbles (230) fastening these hooks. Meanwhile, the continuous fiber composite material (240) is integrated into the holes of the ring-type thimbles (230).

Therefore, the lashing bar made of a composite material manufactured through the present invention (300) provides light weight and capacity to withstand tensile loads.

The foregoing description illustrates an embodiment of the invention pertaining to the manufacturing of eye-type lashing bars, but it will become apparent to those skilled in the art having read this detailed description that they can manufacture knob-type lashing bars through the alignment of continuous fibers through the above-described process of assembling the lashing bar forming mold (200) using the cylindrical core (210) on which stoppers are formed lengthwise at certain intervals.

The disclosed embodiment of the present invention is given by way of illustration only, and various changes and modifications within the spirit and scope of the invention will become apparent to those skilled in the art. Therefore, such changes and modifications may be made without departing from the scope of the invention defined in claims.

1. A method of manufacturing lashing bars made of composite material, comprising,
(a) forming a forming mold for a lashing bar by assembling a first thimble made of a metallic material on a first end of a cylindrical core made of a metallic material and a second thimble made of a metallic material on a second end of the cylindrical core;
(b) loading the forming mold onto a filament winding machine;
(c) winding continuous fibers around an outer circumference of the forming mold, by going and coming back from the first thimble to the second thimble via an outer surface of the cylindrical core, using filament winding technique; and
(d) curing the continuous fibers wound around the outer circumference of the forming mold to form a lashing bar in which the cylindrical core is included inside cured continuous fibers,
wherein the step of (c) includes:
(c1) aligning the continuous fibers passing through the first thimble or the second thimble at 0 degree lengthwise on the outer surface of the cylindrical core;
(c2) winding the continuous fibers passing through the first thimble or the second thimble on the outer surface of the cylindrical core at degrees not exceeding ±15 lengthwise along said cylindrical core;
(c3) winding the continuous fibers passing through the first thimble or the second thimble on the outer surface of the cylindrical core at ±40 to ±50 degrees lengthwise along the cylindrical core; and
(c4) repeating the steps of (c1) to (c3) in order a plurality of number of times while applying a tension on the continuous fibers.

2. The method of claim 1, wherein the continuous fibers include glass fiber having tensile strength 3,1000-3,800 Mpa and tensile elasticity 75-78 Gpa,

3. The method of claim 1, wherein the continuous fibers include carbon fiber having tensile strength 4,200-6,100 Mpa and tensile elasticity 230-300 Gpa.

4. The method of claim 1, wherein the continuous fibers include aramid fiber having tensile strength approximately 3,600 Mpa and tensile elasticity 41-186 Gpa.

5. The method of claim 1, wherein the continuous fibers include polyethylene fiber having tensile strength 2,200-3,500 Mpa and tensile elasticity 89-116 Gpa.
